(19) United States
(12) Patent Application Publication
(10) Pub. No.: US 2013/0017359 A1
(43) Pub. Date: Jan. 17, 2013

(54) Preparation Of Lignocellulosic Products

(71) Applicants: David Selley, Bay City, MI (US); Andreas Stammer, Pont-A-Celles (BE)

(72) Inventors: David Selley, Bay City, MI (US); Andreas Stammer, Pont-A-Celles (BE)

(21) Appl. No.: 13/637,572

(22) PCT Filed: Mar. 25, 2011
(86) PCT No.: PCT/US11/30020

§ 371 Date: Sep. 26, 2012

Related U.S. Application Data
(60) Provisional application No. 61/317,862, filed on Mar. 26, 2010.

(51) Int. Cl. C08K 5/1545; C08K 7/02; B32B 5/16; C08L 79/00; B32B 5/12; C08K 5/544; C08K 7/00

(52) U.S. Cl. 428/106; 524/42; 428/221

(57) ABSTRACT

A lignocellulosic composite composition comprising: a) lignocellulosic pieces, b) one or more organic binders, c) hydrophobing agent in the form of a silicon containing material selected from (i) phenyl silsesquioxane resin, (ii) a reaction product of an aminosilane and alkylsilane, (iii) a resin emulsion and (v) a polydiorganosiloxane polymer having at least 2 Si—H groups having at least 2 Si—H groups per molecule in combination with either an aminosilane or an aminosiloxane or, in the absence of said aminosilane and said aminosiloxane when at least one organic binder (b) comprises primary or secondary amino groups. The hydrophobing agent is present in the composition in an amount of from about 0.05 to 3% by weight of the composition and is optionally wax free. Methods of preparation and uses are additionally discussed.

The present invention generally relates to lignocellulosic products comprising a plurality of lignocellulosic pieces and a binding agent, lignocellulosic composites, articles formed therefrom and to methods of forming the lignocellulosic products and/or lignocellulosic composite articles.

Lignocellulosic composite articles, such as oriented strand board (OSB), oriented strand lumber (OSL), particleboard (PB), scrimber, agrifiber board, chipboard, flakeboard, and fiberboard, e.g. medium density fiberboard (MDF), are generally produced by blending or spraying lignocellulosic pieces with a binding agent, while the lignocellulosic pieces are mixed in a suitable mixer or similar apparatus. After initial mixing a binding agent/lignocellulosic pieces mixture is prepared wherein, the lignocellulosic pieces, which are typically coated with the binding agent. This resulting mixture is subsequently formed into a product which might be suitably described as loosely bonded platter. This loosely bonded board is then compressed, at temperatures of from about 100° C. to about 250° C. optionally in the presence of steam (which may be introduced as part of the process or produced from moisture extracted from the lignocellulosic pieces in the loosely bonded platter). The compression step is utilised to set the binding agent and bond the lignocellulosic pieces together in a densified form i.e. in the form of a board or panel or the like.

The lignocellulosic pieces used in the above process may be in the form of chips, shavings, strands, scrim, wafers, fibers, sawdust, bagasse, straw and wood wool. The lignocellulosic composite articles produced by the process are known in the art under the general term of “engineered wood” in the cases when the lignocellulosic pieces contained therein are relatively larger in size, e.g. from 2 to 20 cm.

Engineered woods are manufactured under a variety of names including, for the sake of example, wafer board, laminated strand lumber, OSB, OSL, scrimber, parallel strand lumber, and laminated veneer lumber. Smaller lignocellulosic pieces such as, for example sawdust and the like are used in the preparation of e.g. particleboard and different types of fibreboard such as MDF and scrimber are thin, long, irregular pieces of wood having average diameters ranging from about 2 to 10 mm and lengths several feet in length.

The engineered woods were developed because of the increasing scarcity of suitably sized tree trunks for cutting lumber. Such engineered woods can have advantageous physical properties such as strength and stability. Another advantage of the engineered woods is that they can be made from the waste material generated by processing other wood and lignocellulosic materials. This leads to efficiencies and energy savings from the recycling process, and saves landfill space.

The binding agent can comprise a variety of alternatives including, for the sake of example phenol formaldehyde (PF) resins, urea formaldehyde (UF) resins, melamine-formaldehyde resins, resorcinol-formaldehyde resins, isocyanate/urethane resins poly(vinyl acetate) (PVA) and the like.

Isocyanate based binding agents are commercially desirable because they have low water absorption, high adhesive and cohesive strength, flexibility in formulation, versatility with respect to cure temperature and rate, excellent structural properties, the ability to bond with lignocellulosic materials having high water contents, and importantly, zero formaldehyde emissions. Polymeric methylene diphenyl diisocyanate (i.e. polymeric MDI or pMDI) are widely used to treat lignocellulosic materials with the intention of improving the strength of the resulting composite article. Typically, such treatment involves applying the isocyanate to the lignocellulosic material and allowing the isocyanate to cure by, for example, the application of heat and pressure or at room temperature. While it is possible to allow the pMDI to cure under ambient conditions, residual isocyanate (NCO) groups remain on the treated articles for weeks or even months in some instances. It is also known, but generally less acceptable from an environmental standpoint, to utilize toluene diisocyanate (TDI), for such purposes. Isocyanate prepolymers are among the preferred isocyanate materials that have been used in binder compositions to solve various processing problems, particularly, in reducing adhesion to press platens and for reducing reactivity of the isocyanates.

One significant problem with these products are that due to their porous structure these engineered wood materials are subject to high water absorption leading to unacceptable swelling. When exposed to moisture, typically water, boards will swell causing aesthetic problems seen as e.g. increased thickness at edges, strongly reduced mechanical strengths and surface roughness of the boards etc.

Typically waxes are added to the lignocellulosic composite articles to provide water repellency and to reduce swelling of lignocellulosic composite articles when exposed to moisture e.g. water and/or water vapour. A wide variety of waxes are used. Examples include fully-refined or semi-refined paraffin waxes (which can be melts or emulsified suspensions). Semi-refined paraffin waxes (often referred to as slack waxes) are used for OSB and MDF production due to their relative low cost.

The selected wax is added to the lignocellulosic composite article during manufacture and is utilised to fill micro-cracks present in the lignocellulosic composite article, thereby providing the articles with a degree of water repellency and reduction of swelling of the lignocellulosic composite article via physical obstruction of the cracks, which reduces uptake of water. However, especially during prolonged exposure to water, boards containing wax show unacceptable levels of water absorption leading to aesthetical or structural problems in the application.

Another problem regarding these waxes is that their quality may be unacceptably variable as the composition varies due to the variability of the feedstock used for their production. An additional concern for users of such waxes is availability because modern refineries produce significantly less waxes than historically was the case due at least in part to the improvement in catalysts etc.

Furthermore, the waxes generally selected for this purpose are essentially inert to the other components employed in the lignocellulosic composite article and as such do not react with the other components employed in the lignocellulosic composite article.

This means that the selected waxes do not enhance for example, the internal bond (IB) strength of the lignocellulosic composite article, and in some instances may in fact reduce such strength. Similarly, wax does not assist in keeping the lignocellulosic composite article together prior to applying pressure and heat, i.e., while in the loosely bonded platter form, product, a mass, or a “furnish” form, as understood in the art. Furthermore, the need for, high temperatures encountered during manufacture, of the lignocellulosic composite article such as those described above, e.g. during pressing or during steam injection, may lead to sublimation and/or evaporation of the wax from the lignocellulosic composite article. This loss of wax from the lignocellulosic composite article can cause many problems. For example, the build-up of wax can pose a potential fire hazard, with wax building-up and depositing on equipment surfaces. Wax derived vapours can also contribute to the generation of a hydrocarbon haze in a manufacturing facility. In addition, manufacturing costs increase, not only from the physical loss of the wax from the lignocellulosic composite article, e.g. upwards of 50% by weight, but also from clean-up, safety, and housekeeping costs of maintaining a manufacturing apparatus and surrounding area used for making the lignocellulosic composite articles.

There has therefore been a long felt need to replace or enhance the use of these waxes. Silicone based materials have been utilised as discussed in I. B Jusoh, P. Nzokou & P Kamdem, Holz als Roh- and Werkstoff (2005) 63: 266-271. This paper describes the use of a polyalkylsiloxane which was mixed with water and self-emulsified to form a micro-emulsion. The emulsion was sprayed together with a phenol formaldehyde resin onto oven-dried wood flakes to form a flakeboard. The polyalkylsiloxane had a low flash point (67° F.) and showed a detrimental effect on mechanical properties seen in decreased values of the internal bond (according to procedure in ASTM D-1037) when the siloxane content was increased.

US2008/0233341 and US2008/0206572 describe binders for lignocellulose containing materials comprising aminoalkylsilanes. In US2008/0233341 the binder is a specific family of aminoalkylsilanes alone or in a co-condensate with a second silane optionally in the form of an aqueous solution. In US2008/0206572 the binder is a composition based on an aminoalkylsilane and a binder selected from organic resins, isocyanates, natural and near natural binders. US2008/0221318 describes a binder for lignocellulose containing materials comprising a composite resulting from the reaction between a glycidoxypropylalkoxysilane, an organic silica sol and an organic acid catalyst using n-propyl zirconate, butyl titanate or titanium acetylacetonate as a cross-linking agent. It is particularly pertinent to note that in the prior art discussed above the silane based materials used are used as binders making the final product prohibitively expensive because of the cost of the silane based materials.

The inventors have found herein that it is not necessary to replace the traditional binders with expensive silane based materials by utilising a selection of siloxane/silicone resin based products as herein described one can replace traditional waxes in organic binders with suitable silicon containing materials to produce excellent flakeboards having good water resistance and mechanical properties, such as internal bond (IB), modulus of elasticity (MOE) or modulus of rupture (MOR), whilst avoiding the need for replacing the binders as a whole with silane based materials.

In accordance with the present invention there is provided a lignocellulosic composite composition comprising:
a) lignocellulosic pieces
b) one or more organic binders
c) a hydrophobing agent in the form of a silicon containing material selected from
   (i) phenyl silsesquioxane resin,
   (ii) a reaction product of an aminosilane and alkylsilane,
   (iii) a resin emulsion and
   (iv) a polydiorganosiloxane polymer having at least 2 Si—H groups per molecule, in combination with either an aminosilane or an aminosiloxane or, in the absence of said aminosilane and said aminosiloxane when at least one organic binder (b) comprises primary or secondary amino groups;
   which hydrophobing agent is present in the composition in an amount of from about 0.05 to 3% by weight of the composition and is optionally wax free.

The present invention also extends to a lignocellulosic composite article made by curing or the like the above composition.

Wood particle boards like MDF (medium density fibre board) and OSB (oriented strand board) find many applications in construction or for furniture. However due to the nature of wood and the porous structure of these composites, products made out of MDF or OSB show high water absorption leading to unacceptable swelling. In order to reduce the amount of swelling when in contact with liquid water, organic waxes, like slack or paraffin waxes, are added to the boards. These waxes can reduce the swelling to a more acceptable level. However, especially during prolonged exposure to water, even boards containing wax show unacceptable levels of water absorption leading to aesthetical or structural problems in the application. This is seen as e.g. an increased thickness at edges, strongly reduced mechanical strengths and surface roughness. Furthermore the quality of waxes is variable depending on the feedstock used for their production and relatively high amounts need to be used to achieve a desired reduction in water absorption.

Surprisingly it was found that some classes of silicones can reduce the water absorption as well as the thickness swelling and maintain acceptable mechanical properties of boards while other silicones known to be good water repellents (i.e. for mortar, concrete and/or textiles) do not perform as well in this application.

There is also provided a method of preparing such an article comprising the steps of mixing the aforementioned said
a) lignocellulosic pieces
b) one or more organic binders and
c) the hydrophobing agent in the form of a silicon containing material selected from (i) phenyl silsesquioxane resin, (ii) a reaction product of an aminosilane and alkylsilane, (iii) a resin emulsion and (iv) a polydiorganosiloxane having at least two Si—H groups per molecule in combination with either an aminosilane or an aminosiloxane or, in the absence of said aminosilane and said aminosiloxane when at least one organic binder (b) comprises primary or secondary amino groups;
   forming the resulting mixture into an uncured product and subsequently compressing said uncured product at temperatures of from about 100° C. to about 250° C. to set the binding agent and bond the lignocellulosic pieces together.

The lignocellulosic pieces (a) may be in the form of chips, shavings, strands, scrim, wafers, fibers, sawdust, bagasse, straw and wood wool. Preferably the lignocellulosic pieces (a) will be present in an amount of from 85 to 99% by weight of the total composition. More preferably the lignocellulosic pieces (a) will be present in an amount of from 93 to 97% by weight of the total composition

The organic binding agent (b) may be any suitable binder but is preferably selected from phenol formaldehyde (PF) resins, urea formaldehyde (UF) resins, melamine -urea-formaldehyde (MUF), melamine-formaldehyde resins, resorcinol-formaldehyde resins, isocyanate/urethane resins poly(vinyl acetate) (PVA), polymeric methylene diphenyl diisocyanate and the like. Preferably the organic binding agent (b) will be present in an amount of from 1 to 10% by weight of the total composition. More preferably the organic binding agent (b) will be present in an amount of from 3 to 6% by weight of the total composition.

Waxes e.g. fully-refined paraffin waxes or semi-refined paraffin waxes i.e. slack waxes may be present at low levels e.g. up to 3% by weight of the composition, alternatively up to 2% by weight of the composition, alternatively up to 1% by weight of the composition can be present in the composition. Alternatively the compositions as hereinbefore described are wax-free, i.e. they contain 0% wax by weight of the total composition.

Obviously it is to be understood that the total amount by weight of the composition for all compositions in accordance with the invention shall be 100% by weight i.e. the cumulative amount of all components present in a composition shall add up to 100% by weight.

Further ingredients as flames retardants, inorganic fillers, fungicides, pigments or dyes may be added.

As used herein, a phenyl silsesquioxane resin is an organopolysiloxane having at least one siloxy unit of the formula (C₆H₅SiO_{3/2}). Organopolysiloxanes are polymers containing siloxy units independently selected from (R₃SiO_{1/2}), (R₂SiO_{2/2}), (RSiO_{3/2}), or (SiO_{4/2}) siloxy units (also referred herein as M, D, T, or Q units respectively), where R may be any monovalent organic group. These siloxy units can be combined in various manners to form cyclic, linear, or branched structures. The chemical and physical properties of the resulting polymeric structures can vary. For example, organopolysiloxanes can be volatile or low viscosity fluids, high viscosity fluids/gums, elastomers or rubbers, and resins, depending on the selection and amount of each siloxy unit in the organopolysiloxane. Silsesquioxanes are typically characterized as having at least one or several (RSiO_{3/2}) or T siloxy units. Thus, the organopolysiloxanes suitable as the phenyl silsesquioxane resin in the present disclosure may have any combination of (R₃SiO_{1/2}), (R₂SiO_{2/2}), (RSiO_{3/2}), or (SiO_{4/2}) siloxy units, providing it has at least one siloxy unit of the formula (C₆H₅SiO_{3/2}), where C₆H₅ represents a phenyl group.

The phenyl silsesquioxane resin may have an average formula comprising at least 40 mole % of siloxy units having the formula (R′₂SiO_{2/2})ₓ(C₆H₅SiO_{3/2})_{y}, where x and y have a value of from 0.05 to 0.95, and R′ is a monovalent hydrocarbon group having 1 to 8 carbon atoms. As used herein, x and y represent the mole fraction of (R′₂SiO_{2/2}) and (C₆H₅SiO_{3/2}) siloxy units (i.e. D and T-phenyl siloxy units) relative to each other present in the phenyl silsesquioxane resin. Thus, the mole fractions of (R′₂SiO_{2/2}) and (C₆H₅SiO_{3/2}) siloxy units each can independently vary from 0.05 to 0.95. However, the combination of (R′₂SiO_{2/2}) and (C₆H₅SiO_{3/2}) siloxy units present must total at least 40 mole %, alternatively 80 mole %, or alternatively 95 mole % of all siloxy units present in the phenyl silsesquioxane resin.

R′ can be a linear or branched alkyl such as ethyl, propyl, isopropyl, butyl, isobutyl, pentyl, hexyl, heptyl, or octyl group. Typically, R′ is methyl.

The phenyl silsesquioxane resins can contain additional siloxy units such as (i) (R¹₃SiO_{1/2})ₐ, (ii) (R²₂SiO_{2/2})_{b}, (iii) (R³SiO_{3/2})_{c}, or (iv) (SiO_{4/2})_{d} units which are commonly known in the art, and also used herein, as M, D, T, and Q units respectively. The amount of each unit present in the phenyl silsesquioxane resin can be expressed as a mole fraction of the total number of moles of all siloxy units present in the phenyl silsesquioxane resin. Thus, the phenyl silsesquioxane resin of the present invention can comprise the units:

### (i) (R¹₃SiO_{1/2})ₐ

### (ii) (R²₂SiO_{2/2})_{b}

(iii) (R³SiO_{3/2})_{c},
(iv) (SiO_{4/2})_{d},

### (v) (R′₂SiO_{2/2})ₓ and

(vi) (C₆H₅SiO_{3/2})_{y},
wherein
R¹, R², and R³ are independently an alkyl group having from 1 to 8 carbon atoms, an aryl group, or a carbinol group,
R′ is a monovalent hydrocarbon group having 1-8 carbon atoms,
a, b, c, and d have value of zero to 0.6,
x and y each have a value of 0.05 to 0.95, with the provisos that the value of x+y is equal to or greater than 0.40, and the value of a+b+c+d+x+y=1.

The R¹, R², and R³ in the units of the phenyl silsesquioxane resin are independently an alkyl group having from 1 to 8 carbon atoms, an aryl group, a carbinol group, or an amino group. The alkyl groups are illustrated by methyl, ethyl, propyl, butyl, pentyl, hexyl, and octyl. The aryl groups are illustrated by phenyl, naphthyl, benzyl, tolyl, xylyl, xenyl, methylphenyl, 2-phenylethyl, 2-phenyl-2-methylethyl, chlorophenyl, bromophenyl and fluorophenyl with the aryl group typically being phenyl.

For the purposes of this invention a “carbinol group” is defined as any group containing at least one carbon-bonded hydroxy (COH) group. Thus the carbinol groups may contain more than one COH radical such as for example

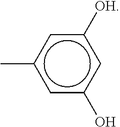

The carbinol group, if free of aryl groups, has at least 3 carbon atoms, or an aryl-containing carbinol group having at least 6 carbon atoms. The carbinol group free of aryl groups having at least 3 carbon atoms is illustrated by groups having the formula R⁴OH wherein R⁴ is a divalent hydrocarbon radical having at least 3 carbon atoms or divalent hydrocarbonoxy radical having at least 3 carbon atoms. The group R⁴ is illustrated by alkylene radicals such as —(CH₂)ₓ— where x has a value of 3 to 10, —CH₂CH(CH₃)—, —CH₂CH(CH₃)CH₂—, —CH₂CH₂CH(CH₂CH₃)CH₂CH₂CH₂—, and —OCH(CH₃)(CH₂)ₓ— wherein x has a value of 1 to 10.

The aryl-containing carbinol group having at least 6 carbon atoms is illustrated

by groups having the formula R⁵OH wherein R⁵ is an arylene radical such as —(CH₂)ₓC₆H₄— wherein x has a value of 0 to 10, —CH₂CH(CH₃)(CH₂)ₓC₆H₄— wherein x has a value of 0 to 10, —(CH₂)ₓC₆H₄(CH₂)ₓ— wherein x has a value of 1 to 10. The aryl-containing carbinol groups typically have from 6 to 14 atoms. Typically, R¹ is a methyl group, R² is a methyl or phenyl group, and R³ is a methyl group.

Any individual D, T or Q siloxane units of the phenyl silsesquioxane resins can also contain a hydroxy group and/or alkoxy group. Such siloxane units containing hydroxy and/or alkoxy groups are commonly found in siloxane resins having the general formula RₙSiO_{(4-n)/2}. The hydroxy groups in these siloxane resins typically result from the reaction of the hydrolyzable group on the siloxane unit with water. The alkoxy groups result from incomplete hydrolysis when alkoxysilane precursors are used or from exchange of alcohol with hydrolyzable groups. Typically, the weight percent of the total hydroxy groups present in the phenyl silsesquioxane resin is up to 40 wt %.

The molecular weights of the phenyl silsesquioxane resins are not restricted, but typically the number average molecular weight (M_{N}) range from 500 to 10,000, or alternatively from 500 to 2,000 measured by GPC.

The viscosity of the phenyl silsesquioxane at 25° C. is not restricted, but typically the viscosity should be lower than 1000 mPa·s, alternatively range from 5 mPa·s to 500 mPa·s. However, resins having a higher viscosity at 25° C. may be used if dissolved in a solvent, as described below as solvents for their preparation. The phenyl silsesquioxane may be used either in a pure form, in solution or form of a suitable emulsion or dispersion.

The phenyl silsesquioxane resins of the present disclosure may be prepared by any method known in the art for preparing siloxane resins having the general formula RₙSiO_{(4-n)/2} where R is an alkyl or aryl group and n is generally less than 1.8. Thus, the phenyl silsesquioxane resins can be prepared by co-hydrolyzing at least one phenylsilane having three hydrolyzable groups such as a halogen or alkoxy group present in the silane molecule with other selected alkylsilanes having two or three hydrolyzable groups such as a halogen or alkoxy group present in the silane molecule. For example, the phenyl silsesquioxane resins can be obtained by co-hydrolyzing alkoxysilanes, such as dimethyldiethoxysilane with phenyltrimethoxysilane, phenyltriethoxysilane, or phenyltripropoxysilane. Alternatively, alkylchlorosilanes may be co-hydrolyzed with phenyltrichlorosilane to produce the phenyl silsesquioxane resins of the present invention. Typically, the co-hydrolysis is performed in an alcohol or hydrocarbon solvent. Alcohols suitable for these purposes include methanol, ethanol, n-propyl alcohol, isopropyl alcohol, butanol, methoxy ethanol, ethoxy ethanol, or similar alcohols. Examples of hydrocarbon-type solvents which can also be concurrently used include toluene, xylene, or similar aromatic hydrocarbons; hexane, heptane, isooctane, or similar linear or partially branched saturated hydrocarbons; and cyclohexane, or similar aliphatic hydrocarbons.

The additional M, D, T, and Q units, as described supra, can be introduced into the phenyl silsesquioxane resins by reacting an additional organosilane(s), selected to produce the desired siloxy unit in the resulting resin during the co-hydrolysis of the alkylsilane and phenylsilane. For example, reacting methoxytrimethylsilane, dimethoxydimethylsilane, trimethoxymethylsilane, tetramethoxysilane (or alternatively the corresponding ethoxy or chlorosilane of each) will respectively introduce a M, D, T, or Q unit into the alkyl-phenyl silsesquioxane resin. The amount of these additional silanes present in the co-hydrolysis reaction are selected to meet the mole fraction definitions, as described supra.

Alternatively, the phenyl silsesquioxane resins can be prepared by reacting an organopolysiloxane and a phenyl silsesquioxane resin using any method in the art known to effect reaction of M, D, T, and Q siloxane units. For example, an diorganopolysiloxane and a phenyl silsesquioxane resin can be reacted by a condensation reaction in the presence of a catalyst. Typically the starting resins are contained in an aromatic hydrocarbon or siloxane solvent. Suitable condensation reaction catalysts are base catalysts including metal hydroxides such as potassium hydroxide and sodium hydroxide; metal salts such as silanolates, carboxylates, and carbonates; ammonia; amines; and titanates such as tetrabutyl titanates; and combinations thereof. Typically, the reaction of siloxane resins is affected by heating the reaction mixture to temperatures ranging from 50 to 140° C., alternatively 100 to 140° C. The reaction can be conducted in a batch, semi-continuous, or continuous process.

The phenyl silsesquioxane resins of this invention are illustrated by phenyl silsesquioxane resins comprising the units;

((CH₃)₂SiO_{3/2})ₓ(C₆H₅SiO_{3/2})_{y}

### Wherein

x and y each have a value of 0.05 to 0.95, with the provisos that the value of x+y is equal to or greater than 0.40.

Optionally, the phenyl silsesquioxane resin can be dissolved in a solvent. A volatile siloxane or organic solvent can be selected as optional component for dissolving or dispersing the phenyl silsesquioxane resin before addition to the aqueous emulsion composition. Any volatile siloxane or organic solvent can be selected providing component A) is dispersible or miscible with the selected solvent. The volatile siloxane solvent can be a cyclic polysiloxane, a linear polysiloxane, or mixtures thereof. Some representative volatile linear polysiloxanes are hexamethyldisiloxane, octamethyltrisiloxane, decamethyltetrasiloxane, tetradecamethylhexasiloxane, and hexadecamethylheptasiloxane. Some representative volatile cyclic polysiloxanes are hexamethylcyclotrisiloxane, octamethylcyclotetrasiloxane, decamethylcyclopentasiloxane, and dodecamethylcyclohexasiloxane. The organic solvent can be an ester, an alcohol such as methanol, ethanol, isopropanol, butanol, or n-propanol, a ketone such as acetone, methylethyl ketone, or methyl isobutyl ketone; an aromatic hydrocarbon such as benzene, toluene, or xylene; an aliphatic hydrocarbon such as heptane, hexane, or octane; a glycol ether such as propylene glycol methyl ether, dipropylene glycol methyl ether, propylene glycol n-butyl ether, propylene glycol n-propyl ether, or ethylene glycol n-butyl ether, an acetate, such as ethyl acetate or butyl acetate, a halogenated hydrocarbon such as dichloromethane, 1,1,1-trichloroethane or methylene chloride, chloroform, dimethyl sulfoxide, dimethyl formamide, acetonitrile, tetrahydrofuran, or an aliphatic hydrocarbon such as white spirits, mineral spirits, isododecane, heptane, hexane or naphtha. Commercially available phenyl silsesquioxane resins that are suitable for the present invention in silicone emulsions as presently disclosed include the following representative, non-limiting examples; DOW CORNING® 3037 Intermediate and DOW CORNING® 3074 (Dow Corning Corp., Midland, Mich.).

The silicon containing material may alternatively be a reaction product of an aminosilane and alkylsilane, preferably in the form of an aqueous solution of a water soluble aminosilane coupling agent and an alkyltrialkoxysilane, wherein the alkyltrialkoxysilane is selected from the group consisting of alkyltrialkoxysilanes with C1 to C8 alkyl groups on silicon and a blend of alkyltrialkoxysilanes each with C1 to C8 alkyl groups on silicon, e.g. methyltrimethoxysilane, ethyltrimethoxy-silane, propyltrimethoxysilane, and isobutyltrimethoxy-silane. The most preferred of the alkyltrialkoxysilanes are either methyltrimethoxysilane and isobutyltrimethoxy-silane, and blends thereof.

Various conventional highly water soluble silane based coupling agents can be used in the present invention. Generally silane coupling agents are of the formula:

E₍₄₋ₚ₎SiDₙ

where E is a monovalent organic radical, D is a hydrolyzable radical, and n is 1, 2, or 3 (most preferably 3). E can be various types of organic radical including alkyl or aryl radicals. D radicals hydrolyze in the presence of water and include acetoxy radicals, alkoxy radicals with 1 to 6 carbon atoms, and alkylalkoxy radicals with 2 to 8 carbon atoms. Silanes containing amino groups are preferred.

Specific silane coupling agents within the scope of the present invention include
N-(2-aminoethyl)-3-aminopropyltrimethoxysilane,
N-(aminoethylaminomethyl)phenyltrimethoxysilane,
N-(2-aminoethyl)-3-aminopropyltris(2-ethylhexoxy)-silane,
3-aminopropyltrimethoxysilane,
trimethoxysilyl-propyldiethylenetriamine,
bis(2-hydroxyethyl)-3-aminopropyltrimethoxysilane and
2-methacryloxyethyldimethyl-[3-trimethoxysilylpropyl]ammonium chloride

The most preferred silane coupling agents include N-(2-aminoethyl)-3-aminopropyltrimethoxy-silane, 3-aminopropyltrimethoxysilane, and the quaternary ammonium functional silanes. The most preferred reaction product of an aminosilane and alkylsilane is commercially available e.g. DOW CORNING® 6184 (Dow Corning Corp., Midland, Mich.).

Preferably the alkyltrialkoxysilane and the aminosilane coupling agent should be present in the aqueous solution in the mole ratio of between about 0.5:1 to about 3.0:1 preferably 1.5:1.0 to about 2.0:1.0, in order to provide stable solutions. Aqueous solutions containing the alkyltrialkoxysilane and the silane coupling agent in mole ratios substantially beyond the range noted above are not entirely satisfactory, and in fact have been found to form gels.

The alkyltrialkoxysilane and the silane coupling agent are also preferably present in the aqueous solution at a level of about two to about forty percent by weight based on the weight of the aqueous solution. More particularly, the alkyltrialkoxysilane and the silane coupling agent are present in the aqueous solutions at a level of about 2.5-20.0 percent by weight based on the weight of the aqueous solution.

The resin emulsion which may be utilised as the hydrophobing agent is preferably of the following composition:

A) 1-70 weight percent of a silicone resin having an empirical formula

$${R}_{x} {Si ( OZ )}_{y} {( O )}_{\frac{4 - x - y}{2}}$$

where
R is a monovalent organic group having 1-30 carbon atoms,
Z is hydrogen or an alkyl group having 1-4 carbon atoms,
x has a value from 0.75 to 1.5,
y has a value from 0.1 to 2.0,

and having a viscosity of from 1 to 2000 mPa·s at 25° C.,
B) 0-40 weight percent of a hydroxy terminated polydiorganosiloxane,
C) 0.5-20% based on the weight of components A) and B) of an emulsifier,
D) 0.001-5% based on the weight of the emulsion of a water soluble salt, with the total % weight of the composition including optional additives, if present is 100%).

The resin emulsion composition contains 1-70 weight percent of a silicone resin having an empirical formula;

$${R}_{x} {Si ( OZ )}_{y} {( O )}_{\frac{4 - x - y}{2}}$$

where
R is a monovalent organic group having 1-30 carbon atoms,
Z is hydrogen or an alkyl group having 1-4 carbon atoms,
x has a value from 0.75 to 1.5,
y has a value from 0.1 to 2.0,
   and having a viscosity of from 1 to 2000 mPa·s at 25° C.

The silicone resins in the emulsions of the present invention are organopolysiloxanes. Organopolysiloxanes are polymers containing siloxane units independently selected from (R₃SiO_{0.5}), (R₂SiO), (RSiO_{1.5}), or (SiO₂) siloxy units, commonly referred to as M, D, T, and Q siloxy units respectively, where R may be any organic group containing 1-30 carbon atoms. These siloxy units can be combined in various manners to form cyclic, linear, or branched organopolysiloxane structures. The chemical and physical properties of organopolysiloxane structures can vary, depending on the type and number of siloxy units present in the organopolysiloxane. For example, organopolysiloxanes can be volatile or low viscosity fluids, high viscosity fluids/gums, elastomers or rubbers, and resins. The organopolysiloxanes useful as silicone resins in the emulsions of the present invention may have any combination of (R₃SiO_{0.5}), (R₂SiO), (RSiO_{1.5}), or (SiO₂) siloxy units, providing the organopolysiloxane has the empirical formula as described above.

Alternatively, the silicone resin A) may be an organopolysiloxane comprising the average formula

[R₂SiO_{2/2}]ₐ[R₂Si(OZ)O_{1/2}]_{b}[R¹SiO_{3/2}]_{c}[R¹Si(OZ)_{2/2})]_{d}[R¹Si(OZ)₂O_{1/2})]ₑ

where the subscripts a, b, c, d and e are the mole fraction of the siloxy unit in the organopolysiloxane and
a is from 0 to 0.4,
b is from 0 to 0.2,
c is from 0.1 to 0.8,
d is from 0.1 to 0.8
e is from 0.01 to 0.2
   with the proviso that a+b is from 0 to 0.4 and c+d+e is from 0.6 to 1.0;
R is a monovalent organic group having 1-30 carbon atoms,
R¹ is an alkyl or aryl group containing 1 to 18 carbon atoms, and
Z is hydrogen or an alkyl group having 1-4 carbon atoms.

The siloxy units in the resin may be in any order. In other words, this formula does not imply an ordering of the designated siloxy units in the formula. Furthermore, the organopolysiloxane may contain additional (R₃SiO_{0.5}), (R₂SiO), (RSiO_{1.5}), or (SiO₂) siloxy units, providing the organopolysiloxane used as the silicone resin in the emulsion has a viscosity of from 1 to 2000 mPa·s at 25° C.

The silicone resins useful as component A) may be prepared by any known method, but are typically prepared by the ring-opening reaction of a cyclic siloxane followed by hydrolytic polycondensation with alkoxysilane(s) or by the hydrolytic polycondensation of alkoxysilanes. In both procedures, the ring-opening, hydrolysis and condensation reactions can be either acid or base catalyzed. These reactions are then followed by catalyst neutralization, distillative removal of by-product alcohol, filtration and removal of solvent to provide the desired product.

For example, an alkylfunctional silicone resin can be manufactured by preparing a mixture of 50-90 wt % of alkyltrialkoxysilane, dialkyldialkoxysilane and/or cyclic siloxanes, dissolving the mixture in up to 50 wt % of a polar solvent. Typically, the polar solvent can be, but is not limited to, methanol, ethanol, propanol, isopropanol and/or butanol. This mixture is then reacted with deionized water (1-20 wt %) using a suitable acid catalyst. Examples of the acid catalyst include, but are not limited to, 0.05 wt % trifluoromethanesulfonic acid (TFMSA) or hydrochloric acid. The reaction is then followed by catalyst neutralization, distillative removal of the by-product alcohol. The mixture is then filtered and heated to remove solvent to yield the desired alkylfunctional resin. Typically the alkyl group is comprised of C1-C18, the typical alkoxy group is hydroxyl, methoxy, ethoxy and/or isopropoxy.

Alternatively, silicone resins can be manufactured by preparing a mixture of 50-90 wt % of alkyltrialkoxysilane, dialkyldialkoxysilane and/or cyclic siloxanes, dissolving the mixture in up to 50 wt % of a polar solvent. Typically, the polar solvent can be, but is not limited to, methanol, ethanol, propanol, isopropanol and/or butanol. This mixture is then hydrolyzed with 1-20 wt % deionized water using a catalytic amount of aqueous potassium hydroxide (or another suitable base catalyst known to those skilled in the art. Examples include, but are not limited to, sodium methylate and potassium silanolate. The reaction is then followed by catalyst(s) neutralization, distillative removal of the by-product alcohol. The catalyst can be neutralized with aqueous HCl (or another suitable acid such as acetic acid). The mixture is then filtered and solvent removed to yield the desired alkylfunctional silicone resin. Typically the alkyl group is comprised of C1-C18, the alkoxy group is hydroxyl, methoxy, ethoxy and/or isopropoxy.

Representative, non-limiting examples of silicone resins suitable as component A) in the present invention include;

[(CH₃)SiO_{3/2}]_{c}[((CH₃)Si(OCH₃)O_{2/2})]_{d}[((CH₃)Si(OCH₃)₂O_{1/2})]ₑ

[((CH₃)₂SiO_{2/2}]ₐ[((CH₃)₂Si(OCH₃)O_{1/2}]_{b}[((CH₃)SiO_{3/2}]_{c}[((CH₃)Si(OCH₃)O_{2/2}]_{d}[CH₃Si(OCH₃)₂O_{1/2})]ₑ

[R²SiO_{3/2}]_{c}[R²Si(OCH₃)O_{2/2})]_{d}[R²Si(OCH₃)₂O O_{1/2})]ₑ

[(CH₃)₂SiO_{2/2}]ₐ[(CH₃)₂Si(OCH₃)O_{1/2}]_{b}[R²SiO_{3/2}]_{c}[R²Si(OCH₃)O_{2/2})]_{d}[R²Si(OCH₃)₂O_{1/2})]ₑ

where R² is n-octyl or methyl, a, b, c, d, and e are as defined above.

### B) The Hydroxy Terminated Polydiorganosiloxane

The emulsions of the present invention contain 0-40 weight percent of a hydroxy terminated polydiorganosiloxane. Thus, component B) is optional, but when present is any polydiorganopolysilxoxane having the general formula;

[R₂Si(OH)O_{1/2}][R₂SiO_{2/2}]_{z}[SiR₂(OH)O_{1/2}],

where R is an organic group containing 1 to 30 carbons and z represents the degree of polymerization and is greater than one. Typically, the hydroxy terminated polydiorganopolysiloxane is a hydroxy terminated polydimethylsiloxane having a degree of polymerization (z) from 1 to 500, alternatively, from 5 to 200, or alternatively from 10 to 100.

### C) The Emulsifier

The emulsions of the present invention contain 0.5-20% based on the cumulative weight of components A) and B) of an emulsifier. While emulsion of the present invention can be prepared by emulsifiers of any type, i.e., anionic, cationic, nonionic and amphoteric, polyvinyl alcohol (PVA) is particularly effective in achieving a film forming system. For example, the components A) and B) can be emulsified by using a nonionic surfactant or a combination of nonionic surfactants having a combined HLB in the range of 10-18, the resultant emulsion, upon water evaporation, leads to a liquid or semi-solidified film on a neutral substrate.

Effective PVA includes those with a degree of polymerization (P_{w}) of 600 to 4000, preferably 2500 to 4000, or a weight average molecular weight M_{w} of 30,000 to 200,000, and with a degree of hydrolysis (from the acetate) of 70 to 98 mol %, preferably 80 to 95 mol %, as measured by Gas phase chromatography (GPC). The use level of the active PVA ranges from 0.5 to 20%, alternatively from 2 to 10%, based on the total weight of components A) and B).

### D) The Water Soluble Salt

The emulsions of the present invention contain 0.001-5% based on the weight of the emulsion of a water soluble salt. The water soluble organic or inorganic salt renders the aqueous phase of the present invention neutral to slightly alkaline at an active level of 0.001 to 5% based on the weight of the emulsion. Examples of water soluble salts that can be used include alkali metal, alkaline earth metal and ammonium salts of carbonates, carboxylic acids, phosphoric acid and acetic acid. Amines are also effective; examples include alkylamine, diethylamine, triethylamine, ethylene diamine, monoethanolamine, diethylethanolamine, and triethanolamine Sodium carbonate or sodium bicarbonate at an active use level of 0.01 to 0.2% based on the weight of the emulsion are particularly effective.

Alternative to alkaline salts, organic or inorganic acid that renders the emulsion slightly acidic can also be incorporated which also results in non-greasy, tack-free films upon water removal. However, an alkaline pH of 7-11 is preferred. More aggressive pH in the acidic or basic ranges is possible so long as it does not adversely affect the stability of the emulsion or the resin.

### Process

The sequence of combining components A), B), C), D) and water or part of the water is not critical. The mixture of the components is then subjected to high shear, in devices such as a rotor stator mixer, a homogenizer, a sonolator, a microfluidizer, a colloid mill, mixing vessels equipped with high speed spinning or with blades imparting high shear, or sonication. The water soluble salt (d) rendering the final aqueous emulsion neutral to slightly alkaline, or acid, can be added either with the water phase prior to high shear, or alternatively, added to the emulsion after it being high sheared. The later procedure provides the emulsion with better stability.

Other additives can also be incorporated in the emulsion, such as fillers, foam control agents; anti-freeze agents and biocides.

As herein before described the hydrophobing agent may alternatively be a polydiorganosiloxane polymer having at least two Si—H bonds per molecule in combination with either an aminosilane or an aminosiloxane or, in the absence of said aminosilane and said aminosiloxane when at least one organic binder (b) comprises primary or secondary amino groups. In other words, the polydiorganosiloxane polymer having at least two Si—H bonds per molecule can be combined with an aminosilane, with an aminosiloxane, or if the at least one organic binder (b) itself comprises primary or secondary amino groups, then there is no requirement that the polydiorganosiloxane polymer having at least two Si—H bonds per molecule be combined with an aminosilane or with an aminosiloxane.

The polydiorganosiloxane may be linear or cyclic and may contain a degree of branching but preferably the majority of groups in the polymer are D groups as hereinbefore described. The polymer may be a linear polydiorganosiloxane polymer having at least two Si—H bonds. In the case of a linear polymer the Si—H bonds may situated on terminal groups but this is not essential. One preferred linear polydiorganosiloxane polymer having at least two Si—H bonds is depicted below:—

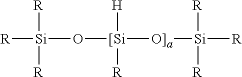

wherein each R is the same or different and represents a hydrocarbon group having from one to eight carbon atoms and a has an average value of between 20 and 500, alternatively an average value between 20 and 200. The polysiloxane of the above general formula should consist largely of methylhydrogen siloxane D units, but may contain other species of siloxane unit, for example dimethyl siloxane units, provided hydrophobing performance is not affected. Preferably at least 25% of the total siloxane units are methylhydrogen units, more preferably at least 50%.

Alternatively the polydiorganosiloxane polymer having at least two Si—H bonds may be cyclic. Typically such cyclic polymers contain at least four D groups, typically from 4 to 100 D groups with at least 2 methylhydrogen siloxane D units per molecule.

In a further alternative the polydiorganosiloxane polymer having at least two Si—H bonds may be a siloxane based copolymer. The polydiorganosiloxane polymer having at least two Si—H may be used pure, as solution or in form of an emulsion or dispersion

When the binder (b) contains no primary or secondary amino groups, the polydiorganosiloxane polymer having at least two Si—H bonds is utilised in combination with an aminosilane or quaternary ammonium functional silane. Any suitable aminosilane (i.e. primary, secondary tertiary or quaternary ammonium functional silanes) may be utilised but preferred examples of suitable aminosilanes and quaternary ammonium functional silanes are:
3-aminopropyltrimethoxysilane, 3-aminopropyltriethoxysilane,
N-(2-aminoethyl)-3-aminopropyltrimethoxysilane,
N-(2-aminoethyl)-3-amino-2-methylpropyldimethoxymethylsilane,
3-aminopropyldiethoxymethylsilane,
trimethoxysilyl-propyldiethylenetriamine and
(trimethoxysilyl)propyldimethyloctadecylammonium chloride
the most preferred being
N-(2-aminoethyl)-3-aminopropyltrimethoxysilane. The aminosilane or quaternary ammonium functional silane, when present in combination with the polydiorganosiloxane polymer having at least two Si—H bonds may be added to the composition neat or in aqueous solution for easier handling, and is preferably present in an amount from 0.01 to 0.3% by weight of the composition.

Furthermore, in the case of use of polydiorganosiloxane polymers having at least two Si—H bonds per molecule in the present invention, a catalyst may be utilised to accelerate the rate of reaction. Any catalyst known to promote the reactions of the Si—H bond with water to form silanols and or condensation of silanols can be used. Typically such catalysts are acids such as HCl, H₂SO₄, acid clay, Lewis acids (e.g. ZnCl₂, MgCl₂, BF₃) or bases such KOH, NaOH, NH₃, RONa, ROK, M₃SiK, Siliconates (e.g. Methylsiliconates), amines (e.g. piperidine).

Any suitable aminosiloxane may be utilised. The amino siloxane may contain one or a plurality of amino groups, typically an polydimethylsiloxane having at least one amino group. Preferably the amino groups are primary or secondary amino groups. The viscosity of the aminosiloxane is preferably between of 5-10000 mPas, preferably 10-1000 mPa·s at 25° C.

When the binder (b) contains primary or secondary amino groups, the polydiorganosiloxane polymer having at least two Si—H bonds is utilised in the absence of aminosilane as described above. This may be the case e.g. when the binder (b) includes materials such as ureaformaldehyde resins and the like.

Different silicones known to be good water repellents in different applications were added during the process of making oriented strand board panels using a hot press. The level of silicone was approximately 0.5% by weight and all board were prepared using 5% resin. A reference board containing 1.5% of an organic wax was used as a reference. Surprisingly the edge thickness swell for boards containing certain classes of

was significantly reduced versus the reference for 24 hours immersion (tests done according to ASTM D1037-06a). Other silicones based mainly on polydimethyl chains and alkylsilanes showed performance similar or inferior to the reference containing wax.

In order to evaluate improvements in the formulation of OSB, it is not practical to produce full-size, factory scale boards since the experiments and trials needed to evaluate improvement can easily number in the hundreds. There are many scaled-down process for making OSB composite boards, but these are mostly in place at large Universities or institutes that specialize in the study of wood-based composites. These scaled-down process are still much larger than could be effectively implemented for a laboratory study, and using these facilities would add a significant cost and time element to any evaluation of Si-based additives.

### EXAMPLE 1

### Lab-Scale Board Production

While not practical to completely copy the operations used in a factory, it has been possible to utilize the same basic operations on a laboratory scale to make smaller composite boards. In summary the lab-scale method for making boards has the following steps:
1) Strand Production: Wood strands are produced commercially by cutting and processing trees using specialized machinery to produce strands of a usable size and shape. Strand size varies considerably, but they are typically 1″ to 6″ (2.54 cm to 15.24 cm) in length with an aspect ratio (length to width) of 3:1 or greater and with a typical thickness of about 0.01 to 0.05 in thick. (0.25 to 1.27 mm), Wood species also vary; common species include but are not limited to: pine, aspen, oak, maple, fir, and gum varieties. For laboratory evaluation, commercially produced strands are further cut to yield approximately a 1:1 aspect ratio, and the strand size is targeted to be about 1″×1″ (25.4 mm×25.4 mm)
2) Drying: The pre-dried strands are allowed to condition in a controlled temperature and humidity room for several days, and under these conditions equilibrate to between 6% and 8% moisture content.
3) Coating: The strands are placed in a metal pail or container which has been modified with internal baffles and vents such that it can be rotated on rollers. One end has an opening through which the resin adhesives and other additives can be sprayed using a suitable spray gun while the strands are tumbled continuously. The conditions are controlled so that there is a positive airflow through the container to allow even coating. The amount of material applied to the strands is determined by direct weight measurements, and with experience the weight can be correlated to spray times to increase efficiency.
4) Mat assembly: The coated strands are carefully placed in a form such that the flakes are laying in a horizontal position and producing a uniform mat several layers deep. The form is made up of multiple layers of elastomeric material, and the mat is cold pressed with successively decreasing form thickness to make a more compressed, but un-cured mat. (This allows for inspection and adjustment as needed to produce a uniform thickness and density before press curing).
5) The compressed mat is placed in a heated hydraulic laboratory press. When closed, the press applies the prescribed amount of pressure while maintaining the temperature sufficient to cure the resin system used. Different conditions can be used, but one useful set of conditions has been to use a temperature of 150° C. and 400-500 psi of pressure (2758 kPa to 3448 kPa). This has produced uniform boards of the targeted density (35-50 lb/cubic foot (560.7 kgm-3 to 801.9 kgm-3).
6) The boards are trimmed using a standard shop saw, fitted with a smooth cutting blade (suitable or recommended by the blade manufacturer for plywood or composite materials), to a usable size for evaluating thickness swell performance and internal bond strength.

For examples relating to the current invention, a simplified OSB formulation utilizing only one binder (adhesive) resin was used to minimize formulation effects or ingredient interactions. The resin level was held constant, and the hydrophobing additive was either a wax, or a silicone species as described:
100 parts wood strands.
5 parts pMDI resin¹
1.5 parts slack wax
0.5 parts silicone additive.

Water Absorption and Thickness Swelling, Specific Gravity, Tension Perpendicular to Surface (Internal Bond Strength) and other measured properties are evaluated using methods consistent with ASTM D-1037-06a.

### EXAMPLE 2

### Comparative Performance

Using the OSB lab scale method of Example 1, and by varying the additive, the following comparative examples in Table 1 show the performance of silicones versus wax.

TABLE 1

| | | | Additive | | |
|---|---|---|---|---|---|
| | Strands | p-MDI | Amount | Additive | ETS 24 hours |
| Example | (g) | (g) | (g) | Type | (%) |
| 1 | 300 | 22.5 | 8.6 | 1 | 15.9 |
| 2 | 300 | 16.2 | 7.8 | 2 | 15.2 |
| 3 | 300 | 20 | 10 | 3 | 16.5 |
| 4 | 300 | 16.9 | 7.9 | 4 | 15.6 |
| Ref | 300 | 16.0 | none | None | 19.6 |
| Compara- | 300 | 15.3 | 8 | Cl | 16.7 |
| tive 1 | | | | | |
| Compara- | 300 | 15.22 | 7.52 | C2 | 19.2 |
| tive 2 | | | | | |
| Compara- | 300 | 16.28 | 7.7 | C3 | 18.0 |
| tive 3 | | | | | |
| Compara- | 300 | 16.2 | 7.6 | C4 | 19.2 |
| tive 4 | | | | | |
| Compara- | 300 | 16 | 7.8 | C5 | 25.8 |
| tive 5 | | | | | |

ETS = Edge thickness swelling
The ETS values are the average of two boards tested for each formulation

Additive 1 is an aminosilsesquioxanes, methoxy-terminated (reaction product of (ethylenediaminepropyl)trimethoxysilane and methylrimethoxysilane) diluted in water to 20% active content.
Additive 2 is Dow Corning® IE-2404 Emulsion is a commercially available resin emulsion in accordance with the resin emulsions as described in the present invention (at the time of the priority document of the present invention.
Additive 3 is an emulsion of trimethyl terminated methylhydrogensiloxane diluted in water to 20% active in the presence of 0.02_% 3-(trimethoxysilyl)propyldimethyloctadecylammonium
Additive 4 is trimethyl terminated methylhydrogensiloxane having a viscosity of 30 mPa·s at 25° C. polymer in emulsion with polyvinyl alcohol emulsion diluted in water to 20% active in the presence of 0.02% hydrolysed N-(2-aminoethyl)-3-aminopropyltrimethoxysilane.
C1 is an emulsion of slack wax with approx 60% active content.
C2 is Dow Corning® IE 6683, a general purpose Silicone water repellent diluted in water to 20% active content (i.e. 20% by weight Dow Corning® IE 6683 and 80% by weight water)
C3 is an emulsion of n-octyl silsesquioxane diluted in water to 20% active content
C4 is Dow Corning® 2-1251 diluted in water to 20% active content
C5 is an emulsion of trimethyl terminated methylhydrogensiloxane having a viscosity of 30 mPa·s at 25° C. polymer in polyvinylalcohol diluted in water to 20% active content.

The silicone resinous materials are either preformed or generated during the wood particle board production in situ by using suited precursors and catalysed reactions. Preferably the precursors are not volatile due to the high temperature employed during the wood board manufacturing. None reactive linear silicones like trimethylsilyl terminated polydimethyl siloxane (PDMS) do not show the desired improvement.

### EXAMPLE 3

OSB made on pilot equipment Aspen strands were dried and equilibrated to 8% moisture content in a dehumidification dry kiln. Boards were produced with a polymeric diphenylmethane diiisocyanate (pMDI) resin (supplied by Huntsman under the tradename Rubinate M). The target resin loading was 4% (based on oven dry wood weight). Boards of 34 inch (86.36 cm) by 34 inch (86.36 cm) size and 0.715 inch (1.82 cm) thickness were produced using a hot press with a plate temperature of 400° F.

Boards containing 0.2% of Additive 4 in Example 2 were prepared and compared to a reference containing no additive. Water absorption and thickness swell were determined according to ASTM D1037-06 using 6 inch (15.24 cm) by 6 inch (15.24 cm) specimens. The internal bond strength was determined in accordance with ASTM D1037-99. The Table 2 provides give the average results for 3 boards made with Additive 4 and 3 reference boards containing no additive.

TABLE 2

| | Water absorption | Edge thickness | Internal Bond |
|---|---|---|---|
| | % wt | swell % | (kPa) |
| 0.2% Additive 4 | 31.8 | 14.8 | 768.1 |
| No additive | 43.8 | 16.5 | 108.4747.4 |

The results show that Additive 4 reduced the water absorption and edge thickness swell of an OSB board without reducing the Internal Bond strength.

### EXAMPLE 4

Bond strength for particle board application. The following mixtures were prepared using a urea formaldehyde resin (supplied by Dynea having a solid content of 67.8%) and Additive 2 as described in Example 2 above 50% active emulsion) and Additive 5 (Dow Corning® SF 75, a commercially methylhydrogensiloxane 60% active emulsion).

| | | Urea |
|---|---|---|
| Example | Additive | formaldehyde |
| 4a | 0.1 g Additive 2 | 4.9 g |
| 4b | 0.083 g Additive 5 | 4.917 g |
| 4 comparative | None | 5 g |

It is of note that in the case of Additive 5 that the essential amino (N—H containing) group is provided by the resin and not by a separate aminosilane etc.

The mixtures were evaluated using an automated bond evaluation system (ABES). This system is pressing two veneers (beech wood of 25 mm by 100 mm size) with resin together, cooling and pulling them automatically. The following parameters were used.
0.25 g resin or resin/additive mix per pull
Plate temperature: 200° C.
Press time: 15 s
Pull speed 1 mm/min
   The following table shows the tensile strengths for the different formulations. The values given are the average of 20 samples evaluated.

| | Tensile strength |
|---|---|
| Example | (MPa) |
| 4a | 4.0 |
| 4b | 4.3 |
| 4 comparative | 3.7 |

The results show that surprisingly the tensile strength of the resin is increased. The additives were used to prepare particle boards using the same resin.

1. A lignocellulosic composite composition comprising:
a) lignocellulosic pieces;
b) one or more organic binders; and
c) a hydrophobing agent in the form of a silicon containing material selected from
(i) phenyl silsesquioxane resin,
(ii) a reaction product of an aminosilane and alkylsilane,
(iii) a resin emulsion, and
(iv) a polydiorganosiloxane polymer having at least 2 Si—H groups per molecule in combination with either an aminosilane or an aminosiloxane or, in the absence of the aminosilane and the aminosiloxane when at least one organic binder (b) comprises primary or secondary amino groups;
wherein the hydrophobing agent is present in the composition in an amount of from about 0.05 to 3% by weight of the composition and is optionally wax free.

2. A lignocellulosic composite composition in accordance with claim 1 wherein the lignocellulosic pieces (a) are selected from chips, shavings, strands, scrim, wafers, fibers, sawdust, bagasse, straw and wood wool.

3. A lignocellulosic composite composition in accordance with claim 1 wherein the organic binding agent (b) is selected from one or more of phenol formaldehyde (PF) resins, urea formaldehyde (UF) resins, melamine-urea-formaldehyde (MUF), melamine-formaldehyde resins, resorcinol-formaldehyde resins, isocyanate/urethane resins poly(vinyl acetate) (PVA) and polymeric methylene diphenyl diisocyanate (pMDI).

4. A lignocellulosic composite composition in accordance with claim 1 wherein the hydrophobing agent (c) is a phenyl silsesquioxane resin having at least one siloxy unit of the formula (C₆H₅SiO_{3/2}).

5. A lignocellulosic composite composition in accordance with claim 4 wherein the phenyl silsesquioxane resin has an average formula comprising at least 40 mole % of siloxy units having the formula in (R′₂SiO_{2/2})ₓ(C₆H₅SiO_{3/2})_{y}, where x and y represent mole fractions and have a value of 0.05 to 0.95, and R′ is a monovalent hydrocarbon group having 1 to 8 carbon atoms.

6. A lignocellulosic composite composition in accordance with claim 1 wherein the hydrophobing agent (c) is the reaction product of an alkyltrialkoxysilane and an aminosilane selected from:
N-(2-aminoethyl)-3-aminopropyltrimethoxysilane,
N-(2-aminoethyl)-3-aminopropyltriethoxysilane,
3-aminopropyltrimethoxysilane, and
3-aminopropyltriethoxysilane.

7. A lignocellulosic composite composition in accordance with claim 1 of the following composition:
A) 1-70 weight percent of a silicone resin having an empirical formula
$${R}_{x} {Si ( OZ )}_{y} {( O )}_{\frac{4 - x - y}{2}}$$
where
R is a monovalent organic group having 1-30 carbon atoms,
Z is hydrogen or an alkyl group having 1-4 carbon atoms,
x has a value from 0.75 to 1.5,
y has a value from 0.1 to 2.0,
and having a viscosity of from 1 to 2000 mPa·s at 25° C.,
B) 0-40 weight percent of a hydroxy terminated polydiorganosiloxane,
C) 0.5-20% based on the weight of components A) and B) of an emulsifier, and
D) 0.001-5% based on the weight of the emulsion of a water soluble salt with the total weight of the composition being 100%.

8. A lignocellulosic composite composition in accordance with claim 1 wherein the hydrophobing agent (c) is a linear polydiorganosiloxane polymer having at least 2 Si—H bonds of the formula: 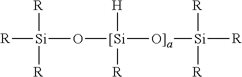
wherein each R is the same or different and represents a hydrocarbon group having from one to eight carbon atoms and a has an average value of between 20 and 200.

9. A lignocellulosic composite composition in accordance with claim 1 wherein the hydrophobing agent (c) is a cyclic polydiorganosiloxane polymer having at least 4 D groups, with at least 2 methylhydrogen siloxane D units per molecule.

10. A lignocellulosic composite composition in accordance with claim 8 containing an aminosilane.

11. A lignocellulosic composite article made by curing the composition of claim 1.

12. A lignocellulosic composite article in accordance with claim 11 selected from, plywood, OSB (orientated strand board), MDF medium density fibre board, and particle board.

13. A method of preparing an article comprising the steps of mixing
a) lignocellulosic pieces;
b) one or more organic binders, and
c) a hydrophobing agent in the form of a silicon containing material selected from
(i) phenyl silsesquioxane resin,
(ii) a reaction product of an aminosilane and alkylsilane,
(iii) a resin emulsion, and
(iv) a polydiorganosiloxane polymer having at least 2 Si—H groups per molecule in combination with either an aminosilane or an aminosiloxane or, in the absence of the aminosilane and the aminosiloxane when at least one organic binder (b) comprises primary or secondary amino groups;
forming the resulting mixture into an uncured product and subsequently compressing the uncured product at temperatures of from about 100° C. to about 250° C. to set the binding agent and bond the lignocellulosic pieces together.

14. (canceled)

15. A lignocellulosic composite composition in accordance with claim 1 wherein the composition is free of wax.

16. A lignocellulosic composite article in accordance with claim 8 wherein a majority of the linear polydiorganosiloxane polymer comprises methylhydrogen siloxane D units.

17. A lignocellulosic composite article in accordance with claim 8 wherein at least 25% of the total siloxane units are methylhydrogen units.
